(19) United States
(12) Patent Application Publication
(10) Pub. No.: US 2012/0058456 A1
(43) Pub. Date: Mar. 8, 2012

(54) Casting Training Aid Including A Target Board That Depicts An Aquatic Scene

(76) Inventor: David A. Drinkard, Beaumont, TX (US)

(21) Appl. No.: 13/044,541

(22) Filed: Mar. 9, 2011

Related U.S. Application Data
(60) Provisional application No. 61/312,216, filed on Mar. 9, 2010.

(51) Int. Cl. G09B 19/00

(52) U.S. Cl. 434/258

(57) ABSTRACT

A casting training aid and method of use is disclosed, including a casting target board having a plurality of target holes, with a front side depicting an aquatic scene. The aquatic scene can depict an above-water scene, an underwater scene, and/or a water body surface. The casting training aid can also include at least one obstruction mounted on the target board and/or near target holes. This aid allows a user having a rod, line, and lure or simulated lure to practice casting at the casting training aid in order to improve the user's skill of placing the lure near the fishing target. Scores can be given for engaging a target hole with a lure, with more difficult targets yielding more points. This training aid can be enjoyed by all ages and skill levels indoors or out, in a pool, lake or where ever, while improving an individual's casting skills.

### CROSS-REFERENCE TO RELATED APPLICATIONS

This application is based on the provisional application Ser. No. 61/312,216, filed Mar. 9, 2010, the entire contents of which is herein incorporated by reference.

### FIELD

The present invention generally relates to fishing, and more particularly to developing skill and accuracy in casting a lure to a desired location.

### BACKGROUND

Fishing is a popular sport and leisure activity. Fishing provides a great deal of enjoyment while challenging fishermen and anglers everywhere. One of the most important aspects of fishing is mastering the many difficult techniques associated with casting. Casting is extremely important, as fishermen need to be able to consistently cast a lure into a precise location. This location, typically near a fish, may be obscured by various obstacles. The proper presentation of the lure to fish is critical in fishing. If one were to cast improperly one may spook or frighten the fish away. Spooking the fish is undesirable as the goal is to convince the fish to strike the lure. The best way to improve one's ability to properly cast is practice. However, while casting onto a pond can help a fisherman improve the mechanics of casting, it does not help the fisherman improve the targeted placement of the lure.

To improve precision and accuracy a fisherman must repeatedly cast to specific targets using a variety of techniques. Many varied techniques beyond conventional overhand casting may be used by sport fishermen. For example, when seeking out fish hovering in underwater brush piles, roots, stumps and logs a flipping technique is used. For a constrained target at longer distances where soft landings are desired in order to avoid spooking the fish, a pitching technique may be used. To place a lure under an overhanging obstruction such as a dock, float, tree limb or root a skipping technique may be used to place the lure at the desired location. These approaches all require accuracy on the first try or the fish may be spooked or driven away. Because of the importance of accurately placing lures, practice of these various techniques requires immediate feedback on each individual cast.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### SUMMARY

A casting training aid and method of use is disclosed, including a casting target board having a plurality of target holes, with a front side depicting an aquatic scene. The aquatic scene can depict an above-water scene, an underwater scene, and/or a water body surface. The casting training aid can also include at least one obstruction mounted on the target board and/or near target holes. This aid allows a user having a rod, line, and lure or simulated lure to practice casting at the casting training aid in order to improve the user's skill of placing the lure near the fishing target. Scores can be given for engaging a target hole with a lure, with more difficult targets yielding more points. This training aid can be enjoyed by all ages and skill levels indoors or out, in a pool, lake or where ever, while improving an individual's casting skills.

One general aspect of the invention is a casting training aid. The casting target board includes: a front side and a back side, the front side of the target board depicting an aquatic scene; and a plurality of target holes through both the front side and the back side.

In some embodiments, the aquatic scene includes an image of a surface of a body of water.

In some embodiments, the aquatic scene includes an above-water scene. In some embodiments, the aquatic scene includes an underwater scene.

In some embodiments, the casting training aid further includes: at least one obstruction mounted on the front side of the casting target board, the at least one obstruction being mounted near to a target hole of the plurality of target holes.

In some embodiments, the at least one obstruction is one of: a simulated water-surface level object of the aquatic scene; a simulated above-water object of the aquatic scene; and a simulated underwater object of the aquatic scene.

In some embodiments, the plurality of target holes vary in at least one of: size and shape.

In some embodiments, the fishing target board is capable of being oriented when in use in one of the following orientations: substantially diagonally; substantially vertically; and substantially horizontally.

In some embodiments, the at least one obstruction simulates one of: coral; branches; rocks; piers; and pilings.

In some embodiments, the casting training aid further includes: a plurality of fish targets, each fish target of the plurality of fish targets being located either within or behind a particular target hole of the plurality of target holes.

Another general aspect of the invention is a method for improving casting techniques. The method includes: attaching a lure to an end of a line, the line being coupled to a rod; and casting the lure and line at a casting training aid to permit the lure to engage a target hole, the casting training aid including: a casting target board having a front side and a back side, the front side of the target board depicting an aquatic scene, the casting target board having a plurality of target holes.

In some embodiments, the method further includes: scoring a user, the scoring of the user being based on the lure engaging one of the plurality of target holes, each particular target hole having an assigned score.

In some embodiments, the assigned score of each particular target hole of the plurality of target holes is based on at least one of: size of the particular target hole; shape of the particular target hole; and obstruction near to the target hole.

In some embodiments, the aquatic scene includes an image of a surface of a body of water.

In some embodiments, the aquatic scene includes an above-water scene.

In some embodiments, the aquatic scene includes an underwater scene.

In some embodiments, the method further includes: at least one obstruction mounted on or near the front side of the fishing target board, the at least one obstruction being mounted near a target hole of the plurality of target holes.

In some embodiments, the at least one obstruction is one of: a simulated water-surface level object of the aquatic scene; a simulated above-water object of the aquatic scene; and a simulated underwater object of the aquatic scene.

In some embodiments, the plurality of target holes are capable of engaging a lure cast toward the casting training aid.

In some embodiments, the method further includes using: a plurality of fish targets, each fish target of the plurality of fish targets being located either within or behind a particular target hole of the plurality of target holes.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is a frontal view of a substantially vertically oriented embodiment of the casting training aid, the casting training aid depicting an aquatic scene and having a plurality of target holes;

FIG. 2 is a frontal view of the embodiment shown in FIG. 1, also including an obstruction mounted proximate to one of the target holes;

FIG. 3 is an oblique view of the embodiment shown in FIG. 2, showing a possible angle at which the casting training aid can be oriented;

FIG. 4 is an oblique view of a substantially horizontally oriented embodiment of the casting training aid, the casting training aid depicting an aquatic scene and having a plurality of target holes;

FIG. 5 is an oblique view of the embodiment shown in FIG. 4, also including obstructions mounted proximate to two of the target holes;

FIG. 6 is an oblique view of the embodiment shown in FIG. 5, showing the manner in which a user can use a rod to cast a line and lure; and

FIG. 7 is a flow diagram showing the steps involved in training to improve casting techniques, in accordance with embodiments of the present disclosure.

### DETAILED DESCRIPTION

Preferred embodiments of the present invention are illustrated in the FIGs., like numerals being used to refer to like and corresponding parts of the various drawings.

According to one embodiment of the present disclosure, a casting training aid is provided. This casting training aid may include a substantially horizontal, substantially vertical, and/or substantially diagonal target board, the target board having a number of target holes, and in some embodiments, one or more obstructions mounted proximate to target holes and/or and a number of fish images printed or mounted proximate to the target holes. The substantially horizontal surface is operable to be tilted vertically and the obstructions may be mounted to or proximate to the surface. This casting training aid allows a user having a rod, line, and lure or simulated lure to practice casting at the casting training aid in order to improve the user's skill of placing the lure near the target fish.

Embodiments of the present disclosure may also provide a game aimed at improving/honing skills for casting (e.g. casting fishing lures). By scoring individual casts, players can have fun and compete at the same time. The training aid/game includes a simple game back board (horizontal surface) that is angled with some vertical tilt, but close to horizontal (size of board would depend on complexity/price of game)—the board can me made of wood, foam board or other light/manageable material. The casting training aid board could also consist of a buoyant material allowing the Casting Training Aid to be used or played in a pool or other body of water. The Casting Training Aid will have a variety of underwater images and scenes (e.g. freshwater and saltwater versions), containing underwater fixed structures such as coral reefs, and also underwater moving target and non-target fish. The fish would be strategically placed near target holes cut in the game board.

The smaller or irregularly shaped holes may be worth more points (pounds of fish-to represent tournament weigh-in), since these holes and targets may be more difficult to strike. Larger holes may have less value. The smaller more difficult holes may have images or target fish that represent larger fish. Similarly, smaller fish images or target fish would represent the larger (easier) holes. The shapes and sizes of the holes can vary so as to match up better with the background scenes. The casting training aid can be decorated or provided with extra props to add the level of interest/entertainment and level of difficult: for example, the freshwater version of the casting training aid could be fitted with imitation tree branch and brush inserts over and near hole locations for added difficulty.

Embodiments provide a teaching aid for children and inexperienced adults, as well as experienced fishermen. That may also be used as a game that helps players improve their skills relating to how to cast a rod and reel.

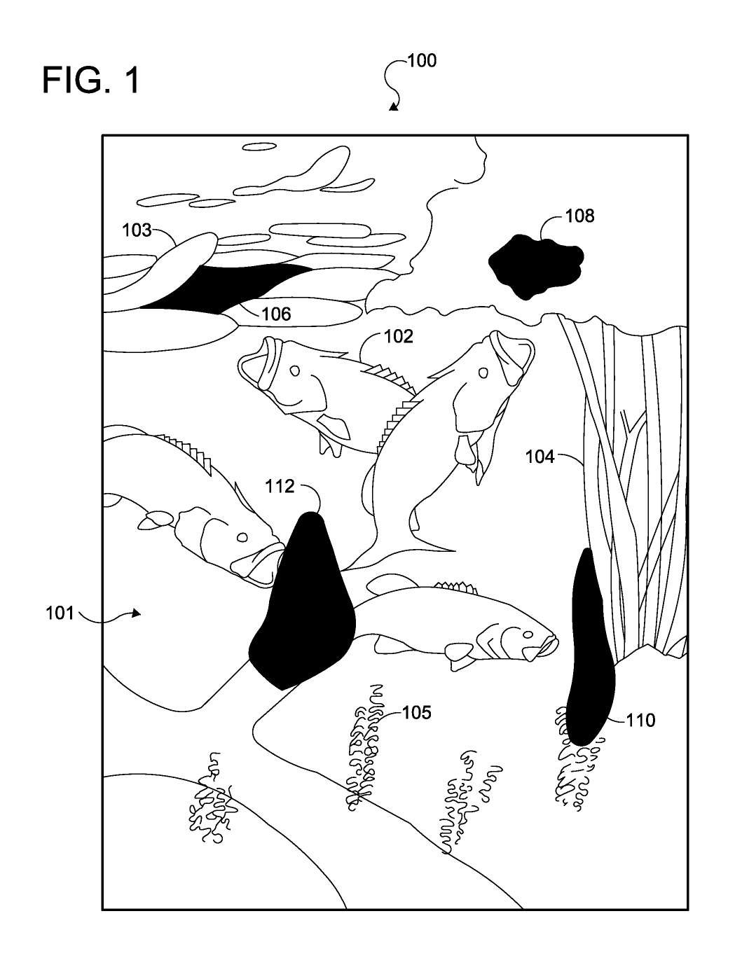

FIG. 1 is a frontal view of a substantially vertically oriented embodiment of the casting training aid, the casting training aid depicting an aquatic scene on its front face and having a plurality of target holes. The casting training aid in the embodiment shown is a substantially vertically oriented target board 100 with an aquatic scene on its front face 101. The aquatic scene 101 can depict above-water objects as well as underwater objects. In the embodiment shown, the aquatic scene 101 depicts objects such as fish 102, lily pads 103, and underwater shrubbery 104, 105.

The target board 10 of the casting training aid also includes a plurality of target holes 106, 108, 110, and 112. In embodiments where the target board is used for a scoring game, holes having a size and/or shape which make them more difficult to penetrate with a lure can yield more points than holes that are easier to penetrate.

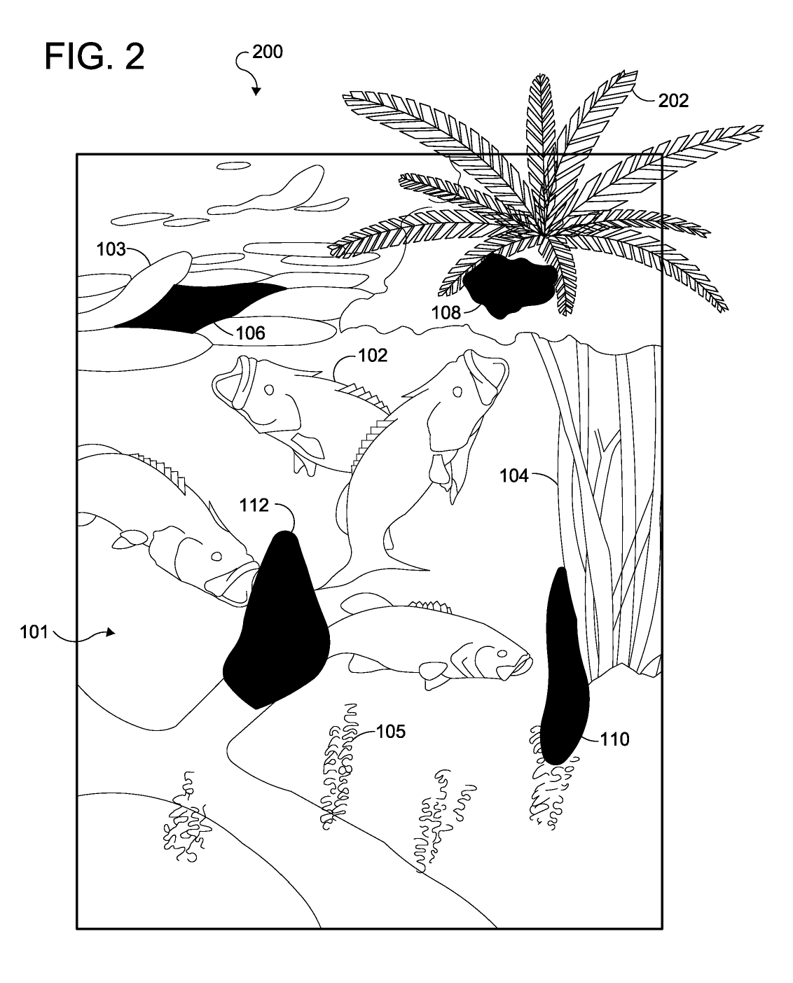

FIG. 2 is a frontal view of the embodiment shown in FIG. 1, also including an obstruction mounted proximate to one of the target holes. The casting training aid of FIG. 2 200 includes an obstruction 202 shown here as a representation of above-water shrubbery. The obstruction can make visibility and penetration of the hole with a lure more difficult, thus increasing the points yielded by the hole, in the event of a scoring game.

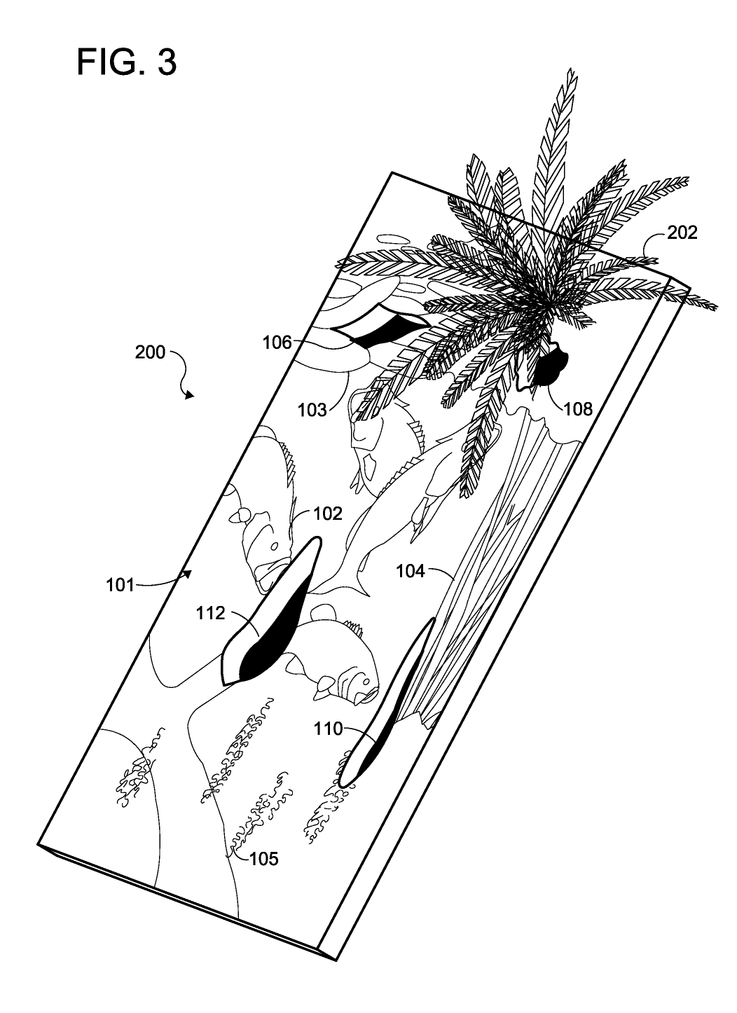

FIG. 3 is an oblique view of the embodiment shown in FIG. 2, showing a possible angle at which the casting training aid can be oriented. In the figure, the casting training aid 200 is shown oriented at an angle that is slightly acute with the ground. The casting training aid 200 is positioned close to vertical, but not quite fully vertical. In the figure, the front face of the casting training aid 200 faces partially upwards due to the slightly acute angle.

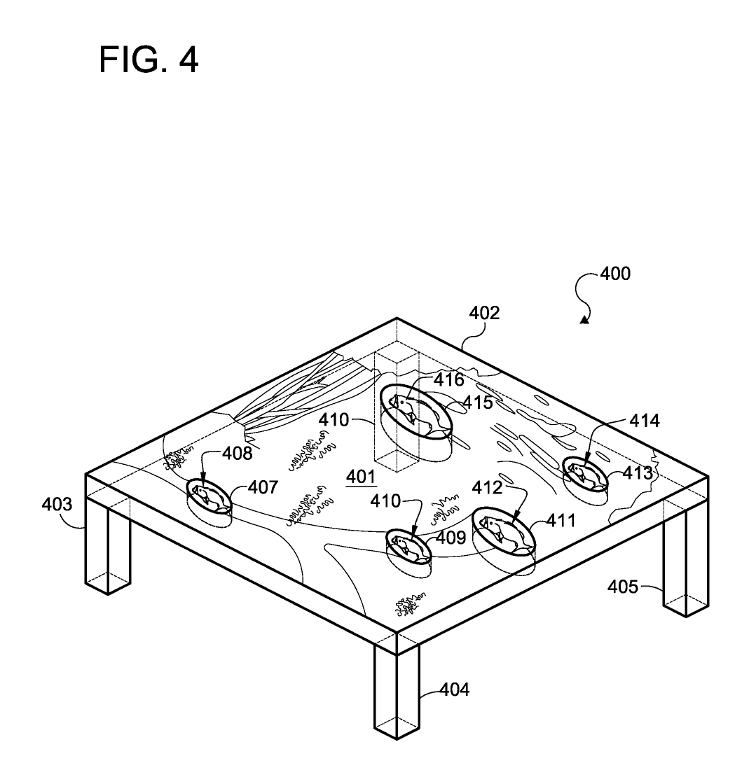

FIG. 4 is an oblique view of a substantially horizontally oriented embodiment of the casting training aid, the casting training aid depicting an aquatic scene and having a plurality of target holes. The casting training aid shown in FIG. 4 400 is a substantially horizontal target board 402 depicting an aquatic scene 401, the target board 402 in this case being a tabletop that is supported by legs 403, 404, 405, 406. The target board 402 also includes a number of holes 407, 409, 411, 413, and 415. In this embodiment, each hole 407, 409, 411, 413, 415 is accompanied by a fish target 408, 410, 412, 414, 416. Such fish targets 408, 410, 412, 414, 416 can be within or behind their respective target holes 407, 409, 411, 413, 415.

In some embodiments, the substantially horizontal surface 402 may be tilted in a more vertical direction. This may be accomplished in some embodiments by providing supporting members 403, 404, 405, 406 with different heights. Tilting the surface 402 allows it to be more easily viewed by a potential user practicing casting, flipping and/or pitching, and it can also change the level of difficulty when engaging the target holes 407, 409, 411, 413, 415.

The horizontal surface 402 may be made from wood, foam or other lightweight manageable material. An aquatic image or scene 401 may be printed on the horizontal surface. An aquatic scene 401 may contain images or even renderings of underwater structures such as coral reefs and/or fish (discussed above in FIGS. 1, 2, and 3). The fish targets 408, 410, 412, 414, 416 may be strategically placed near target holes 407, 409, 411, 412, 415 that are cut in the horizontal surface 402. Target holes 407, 409, 411, 412, 415 may vary in size and shape.

Scoring may involve assigning a greater value to smaller holes than larger holes, as they would be more difficult to strike. Larger holes may be scored less than smaller holes, as they allow a lure or simulated lure to be more easily placed at the hole or target. The shape in the holes, although shown here as circular or elliptical, may vary so as to better match the aquatic scene 401, or to introduce a new level of interest and/or challenge.

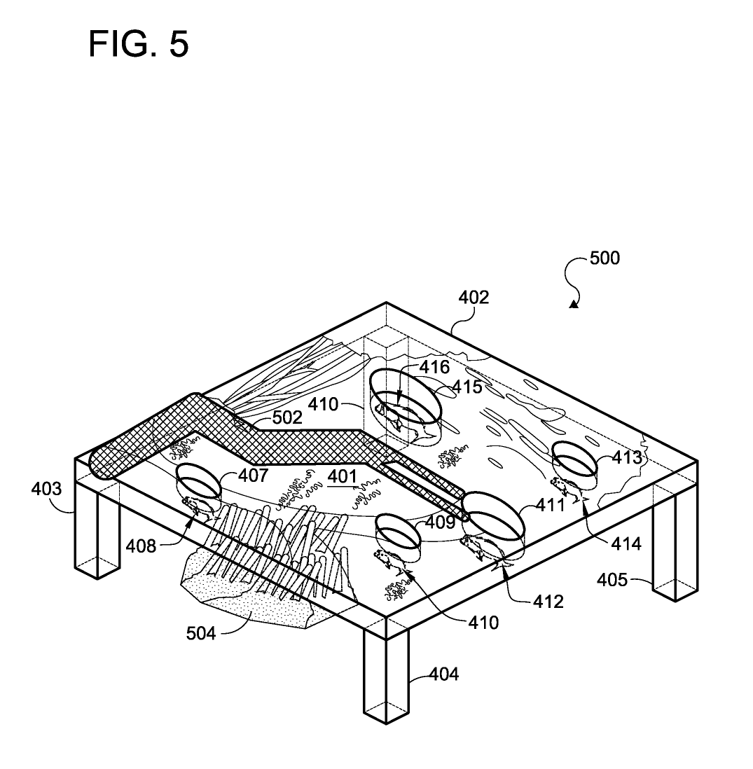

FIG. 5 is an oblique view of the embodiment shown in FIG. 4, also including obstructions mounted proximate to two of the target holes. A simulated branch 502 and coral 504 are included in the embodiment of the casting training aid shown here 500. Such obstructions 502, 504 proximate to the target holes in this simulated casting environment can simulate physical objects that may interfere with casting in a real casting environment. For example, in a freshwater or estuary a branch may be located above the water's surface in a manner similar to the positioning of the simulated branch 502 in the embodiment shown. Such a branch may impede a fisherman's ability to cast toward an intended target. The presence of this simulated above-water obstacle 502 helps train fishermen to cast precisely in the presence of obstacles. Similarly, underwater obstacles such as plants, underwater logs, pilings, rocks and coral may obstruct the fisherman's ability to accurately place the lure proximate to an intended target. The simulated coral obstacle 504 shown in this embodiment can therefore test a fisherman's accuracy in a manner reflective of the challenges faced in real casting environments. Therefore, the placement of above-water obstacles 502 and underwater obstacles 504 relative to certain fish targets 408, 410, 412 helps create scenarios that better train fishermen in the precise placement of their lures.

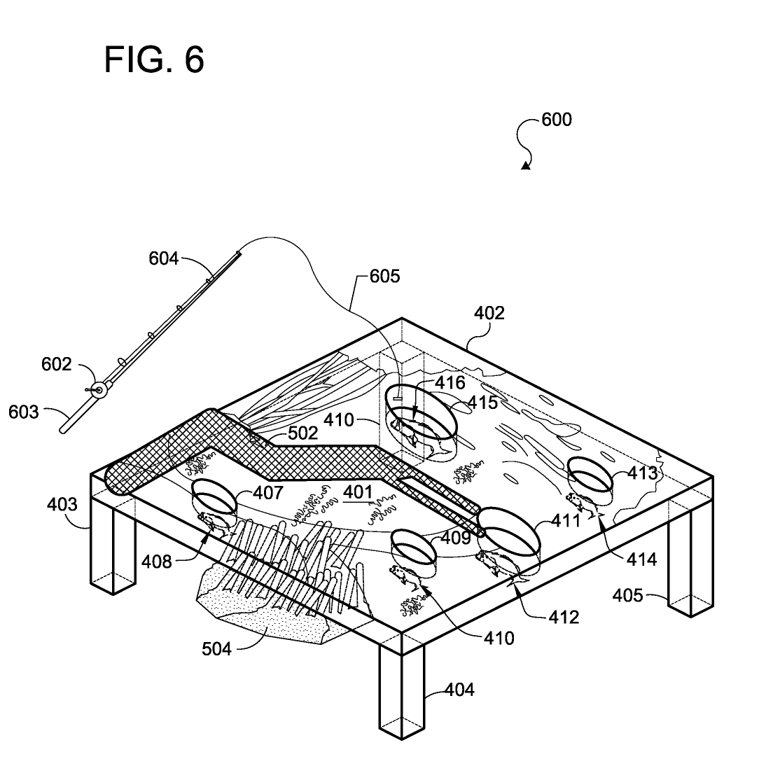

FIG. 6 is an oblique view of the embodiment shown in FIG. 5, showing the manner in which a user can use a rod to cast a line and lure. Shown in this embodiment 600 is a fishing pole 101, which includes a fishing reel 602, a handle 603, a rod 604 and a line 605. A lure can be attached to the line 605, to be cast toward a target hole 415. The lure may be capable of engaging the target hole 415 when the lure is placed proximate to or near the fish target 416. In one embodiment the fish target 416 and lure may be made of magnetic materials which attract when the lure is placed close enough to the fish target 416. In another embodiment, a hook and eye-type fastener such as Velcro may be used to provide engagement between the lure or simulated lure and the fishing target. In still yet other embodiments the hook of a traditional lure may be used to engage the fish target 416.

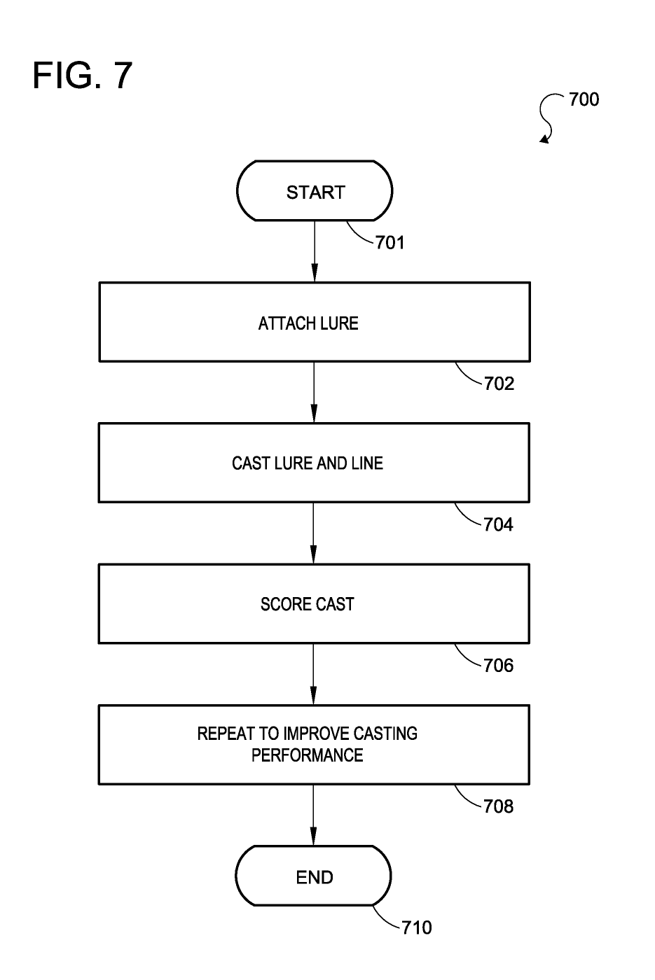

FIG. 7 is a flow diagram showing the steps involved in training to improve casting techniques, in accordance with embodiments of the present disclosure. The flow diagram 700 presents a sequence of steps beginning from the very start of the process 701. First, a lure or simulated lure is attached 702 to a line and rod. This rod, line and lure may be used by fishermen to practice their casting techniques (overhand casting, flipping, pitching or skipping). Next, the lure and line are cast 704 by the training fishermen towards a casting training aid having one or more target holes. These casts may then be scored 706.

Scoring may be based on the physical size of the fishing target and/or hole. For example, a smaller hole, or a hole with obstructed access, may have a higher score associated with it than a larger and/or unobstructed hole. This is due to the fact that more precision and accuracy is required in placing the lure into or near a smaller hole, than that required for a larger hole. In one embodiment the smaller, more difficult holes or targets may have images of larger fish representing them, while smaller (easier) fish images would be placed at larger or easier holes. The shape of these holes and the scores associated with them can vary so as to match up with background images printed on the casting training aid.

The scoring may be affected by the placement of obstructions such as branches, pilings, rocks, plants or other obstructions. These obstructions may provide an added level of interest and entertainment and varying degrees of difficulty. In one particular example a freshwater board may be fitted with an imitation tree branch and/or bush inserts near target locations for increased difficulty. This allows the casting training aid to be used as a game or a teaching aid that helps develop skills in users that relate to casting a rod and reel while making the training fun and exciting. In fact a fun, competitive game for parties and social events may be based on scoring different users' casting techniques.

The prior steps of casting and scoring can then be repeated 708 as needed and desired in order to allow a user to improve their casting techniques with immediate feedback. Fulfillment of this sequence of steps then concludes 710 the process of using the casting training aid in the embodiment shown.

Other modifications and implementations will occur to those skilled in the art without departing from the spirit and the scope of the invention as claimed. Accordingly, the above description is not intended to limit the invention except as indicated in the following claims.

What is claimed is:

1. A casting training aid comprising:
a casting target board having:
a front side and a back side, the front side of the target board depicting an aquatic scene; and
a plurality of target holes through both the front side and the back side.

2. The casting training aid of claim 1, wherein the aquatic scene includes an image of a surface of a body of water.

3. The casting training aid of claim 1, wherein the aquatic scene includes an above-water scene.

4. The casting training aid of claim 1, wherein the aquatic scene includes an underwater scene.

5. The casting training aid of claim 1, further comprising:
at least one obstruction mounted on the front side of the casting target board, the at least one obstruction being mounted near to a target hole of the plurality of target holes.

6. The casting training aid of claim 5, wherein the at least one obstruction is one of:
a simulated water-surface level object of the aquatic scene;
a simulated above-water object of the aquatic scene; and
a simulated underwater object of the aquatic scene.

7. The casting training aid of claim 1, wherein the plurality of target holes vary in at least one of: size and shape.

8. The casting training aid of claim 1, wherein the fishing target board is capable of being oriented when in use in one of the following orientations:
substantially diagonally;
substantially vertically; and
substantially horizontally.

9. The casting training aid of claim 1, wherein the at least one obstruction simulates one of:
coral;
branches;
rocks;
piers; and
pilings.

10. The casting training aid of claim 1, further comprising:
a plurality of fish targets, each fish target of the plurality of fish targets being located either within or behind a particular target hole of the plurality of target holes.

11. A method for improving casting techniques comprising:
attaching a lure to an end of a line, the line being coupled to a rod; and
casting the lure and line at a casting training aid to permit the lure to engage a target hole, the casting training aid including: a casting target board having a front side and a back side, the front side of the target board depicting an aquatic scene, the casting target board having a plurality of target holes.

12. The method of claim 11, further comprising:
scoring a user, the scoring of the user being based on the lure engaging one of the plurality of target holes, each particular target hole having an assigned score.

13. The method of claim 12, wherein the assigned score of each particular target hole of the plurality of target holes is based on at least one of:
size of the particular target hole;
shape of the particular target hole; and
obstruction near to the target hole.

14. The method of claim 11, wherein the aquatic scene includes an image of a surface of a body of water.

15. The method of claim 11, wherein the aquatic scene includes an above-water scene.

16. The method of claim 11, wherein the aquatic scene includes an underwater scene.

17. The method of claim 11, further comprising at least one obstruction mounted on or near the front side of the fishing target board, the at least one obstruction being mounted near a target hole of the plurality of target holes.

18. The method of claim 11, wherein the at least one obstruction is one of:
a simulated water-surface level object of the aquatic scene;
a simulated above-water object of the aquatic scene; and
a simulated underwater object of the aquatic scene.

19. The method of claim 11, wherein the plurality of target holes are capable of engaging a lure cast toward the casting training aid.

20. The method of claim 11, further comprising:
a plurality of fish targets, each fish target of the plurality of fish targets being located either within or behind a particular target hole of the plurality of target holes.
